(19) United States
(12) Patent Application Publication
(10) Pub. No.: US 2019/0141949 A1
(43) Pub. Date: May 16, 2019

(54) Product Dispensing Grooming Device and Method for the Same

(71) Applicant: Jordan Alva, Palm Coast, FL (US)

(72) Inventor: Jordan Alva, Palm Coast, FL (US)

(21) Appl. No.: 15/821,731

(22) Filed: Nov. 22, 2017

Related U.S. Application Data
(60) Provisional application No. 62/425,085, filed on Nov. 22, 2016.

(51) Int. Cl. A01K 13/00

(52) U.S. Cl. CPC A01K 13/002; A01K 13/001

(57) ABSTRACT

The invention disclosed herein is a grooming article which may be beneficial to users and, or manufacturers as it may be quicker, more convenient, easier to store or transport amongst other benefits. A grooming article with layers present suitable for interacting with skin and hair.

### CROSS-REFERENCE TO RELATED APPLICATIONS

This application claims the benefit of U.S. Provisional Application No. 62/425,085, filed Nov. 22, 2016, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### BACKGROUND

I have invented a grooming device that may have several advantages over current grooming devices and, or hair products. Current devices and, or methods may require users to scrape a hair care product out of the product's container (many times this may be a tin) with the back of user's fingernail, then user may have to rub product on hands which may be a messy and wasteful practice and place product in hair (this hair may be beard hair), then user may additionally have to use a separate grooming device to move hair product and, or hair into a desirable position such as moving the product down toward the skin where it may benefit the skin or they may move hair into a particular style.

Prior art may utilize a composition that contains petroleum-based products that some users may not find desirable. Prior art may suggest a skeleton or support system that serves only as a support system when a better multi-purpose system may be available. Prior art may be of a composition or compositions which may not endure standard shipping methods or which may require expensive shipping considerations. Prior art may leave a residue on user's hands when operated.

### BRIEF DESCRIPTION OF THE SEVERAL VIEWS OF THE DRAWINGS

FIG. 1—A side top view of a long side of an embodiment

FIG. 2—A side view of a short side of an embodiment

FIG. 3—A perspective view of a second embodiment

FIG. 4—A side perspective view of a rigid layer without other layers present

FIG. 5—A perspective view of a rigid layer without other layers present

FIG. 6—A top side view of an embodiment with ridges present

FIG. 7—A cross-sectional side view showing a rigid layer, and at least two other layers where the middle layer may be put in place for any beneficial attaching characteristics that it may possess.

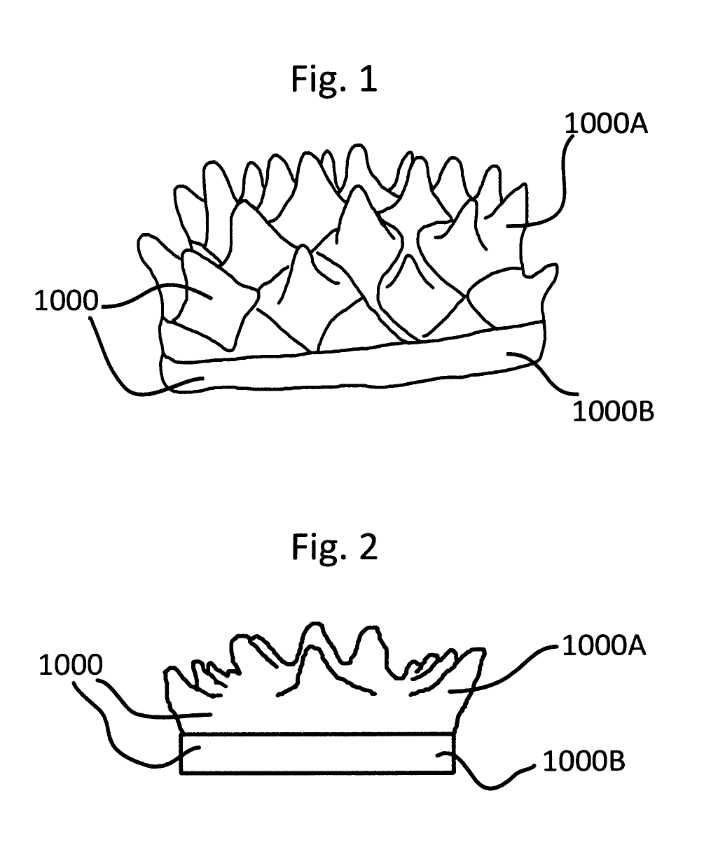

### DETAILED DESCRIPTION

### Advantages

One or more aspects of my invention may present a variety of advantages. One or more embodiments of the invention may dispense hair product as the user grooms his or her hair. One or more embodiments may reduce or eliminate the need for a user to waste time and, or product by placing the grooming product onto their hands or other surface before placing product onto his or her hair and, or skin. One or more embodiments may minimize or eliminate the need for an additional grooming device to move the product and, or hair into a desired final position. A single user may want to dispense multiple types of different hair products onto their hair in a single grooming session or across several grooming sessions. For examples, a user may want to dispense a hair product that is rich in oils and, or butters to promote some type of skin or hair benefit such as moisturizing, conditioning, cleansing, and the same user may want to dispense a different hair product that is rich in wax or clay to help hold their hair in a specific orientation. One or more embodiments of the herein disclosed invention may exhibit the capacity to dispense a variety of hair products. One such case may be a user who wants to put a moisturizing balm into their beard and wants to put a stiffer wax into their mustache. Having multiple products present may make such user's grooming experience faster, more convenient, as well as less frustrating with less products to remember and or store or carry. At least one embodiment exists where varying types of hair product may be present and may be organized in layers. Embodiments with layers may allow the user to apply one type of hair product while the embodiment is in one orientation and a different hair product while the embodiment is in another orientation.

Having multiple layers present may allow different layers to serve multiple purposes. For examples, a rigid layer may act as a support or skeleton of sorts and still be a product that may be applied to the hair and, or skin. A rigid layer may serve as a support and as a lid for container. At least one embodiment may exist where one or more of the layers may have properties that may promote strong forms of attachment of any form including but not limited to cohesion, adhesion, or mechanical attachments. The mechanical attachments may be such as those formed by substances that enter a space in a liquid state and then enter a solid state to create a mechanical attachment or are in a liquid state and have a foreign body enter them prior to them entering a solid state. Having multiple layers where one more of the layers is suitable for a form of attachment may allow for the use of a wider variety of component types, shapes, materials and the like. This wider variety may reduce production costs or a host of other benefits.

Embodiments exist that may allow user to apply product directly to skin or to layers of hair other than the surface layer of hair, and, or apply product to the surface layer of hair. As previously mentioned in the background segment, products that existed prior to this invention may have lent themselves primarily to applying product to the surface layer of hair and then needing an additional grooming device to move said product to a deeper layer of hair or down to the skin. Embodiments may exist which minimize that need. Embodiments exist which may reduce or eliminate the need of a container for hair product. This may reduce waste or cost or contamination of product by container amongst other benefits.

Embodiments exist that may have an entertaining or pleasing shape or design which users may find attractive or desirable.

One or more embodiments may be conducive to shipping with relative ease or minimal expense by means of their composition, packaging or otherwise. One or more embodiments may have one or more layers provided which may keep a user's hands relatively clean or free from residue. One or more layers may have slits, ridges, contours, and, or geometry that may lend to improved application of product.

### A LIST OF REFERENCE NUMERALS

100—Balm
110—Binding Agent
200—Holder
300—Ridges
310—Slits
1000—Layers
1000A—Top Layer
1000B—Bottom Layer
001—Layers
001A—Tines
001B—Attaching layer
001C—Top layer
002—Rigid layer
003—Container
004—Outer lid
005—Inner lid
006—Attachment
007—Series of contours
008—Hole
009—Plug

### One Embodiment

A balm, wax, butter, pomade, clay, glue, essential oil, carrier oil, tonic, cream, gel or gelatin appropriate for hair, hair product (or combinations of these), composition suitable for hair (and, or skin), soap 100 may be present. Balm 100 may be of a consistency that may lend itself to retaining a shape. Making balm 100 with specific ratios of waxes (such as but not limited to beeswax, soy wax, carnauba wax, butters (including but not limited to Shea butter, cocoa butter), oils (including but not limited to carrier oils such as coconut oil, hemp seed oil, apricot kernel oil, olive oil, almond oil, sesame oil, palm oil, argon oil, castor oil, avocado oil, jojoba oil, grapeseed oil, vitamin E oil, vegetable oil, peanut oil, canola oil, etc. or essential oils including but not limited to pine, fir, cedar wood, juniper, lemon, grapefruit, lavender, peppermint, spearmint, rosemary, myrrh, frankincense, sandalwood, cypress, eucalyptus, tea tree, or any other suitable essential oil) aloe vera, glues, gels, and, or clays may promote certain desired traits of balm 100. For example, a balm that is high in beeswax (which has a relatively high melting point for waxes) or clay may tend to retain a specific shape. A balm that has higher butter, oil, cream, or glue content may tend to dispense product more freely. Embodiments exist that may tend to retain their shape in a superior fashion and embodiments exist that may dispense product more freely. Other embodiments exist with other ratios that serve to promote other desired attributes. A binding agent 110 may be present in balm 100. One or more clays and, or any oils present in balm 100 may act as a binding agent 110. Balm 100 may be formed into a shape that may resemble a brush, a pick, a comb, or any other type of grooming device, or any shape that may lend itself to aiding in positioning hair and, or penetrating past a top layer of hair down to a lower layer and, or all the way to the skin. Top layer, tines, or face or both or first contact surface 1000A, and a bottom layer, handle, base, scaffold, or second contact surface 1000B (collectively referred to as layers 1000) may be present. Bottom layer 1000B may be an internal element of one or more embodiments. Embodiments exist where more than two layers are present. Layers 1000 may consist of different substances and, or compositions. Balm 100 may be one of the layers 1000 such as top layer 1000A. Bottom layer 1000B may be made of 100% beeswax. Having multiple layers 1000 may allow an embodiment to have the benefits of both layers. For example, the embodiment may benefit from the rigidity of bottom layer 1000B and from the easier product dispensing nature of top layer 1000A. The relatively pure beeswax bottom layer 1000B may also allow user to use embodiment with minimal hair product residue being left on user's hands. Embodiments exist where bottom layer 1000B may be made of other substances. Bottom layer 1000B may be made of any suitable substance including but not limited to hair products such as mixes of waxes, butters, clays, oils, creams, and aloe vera or any suitable type of plastic, wood, composite material, rubber, glass, or metal and may even be of a material that is flexible before the addition of other layers such as cloth, fiber, filament, etc.

### Operation

A user may grasp the bottom layer 1000B and place top layer 1000B adjacent to skin and, or hair. User may then move embodiment in a specific pattern according to the desired style of hair or according to the area of skin that user wants to receive the benefits promoted by embodiment. User may additionally orient embodiment in a manner that would allow bottom layer 1000B to contact hair or skin and move embodiment in a pattern according to desired hairstyle (including but not limited to facial hair hairstyle) or desired area of skin benefits. Different layers may provide different benefits. A layer made of pure beeswax may provide a stiffer styling hold than a layer that has added butters, oils, etc. Additionally, user may warm embodiment by running it under hot water or placing it in sunlight or any other suitable means of warming before rubbing embodiment on hair or skin or both, or intermittently while using embodiment in order to soften embodiment. User may also cool embodiment to make it firmer. User may change the temperature of embodiment to vary the amount of product that is dispensed.

### Second Embodiment

A 2nd embodiment exists.

A 2nd embodiment may exist. A plurality of layers 001 may be present Layers 001 may be made of any suitable material including but not limited to the materials listed earlier in association with balms. As with other embodiments, one or more layers may be formed in the shape of a comb, brush, or other shapes with tines, ridges, slots, or grooves 001A suitable for repositioning hair or distributing product along skin or hair. One or more of the layers 001 may be a rigid layer 002 and may be made of any suitable material including but not limited to wood, plastic, metal (including aluminum, steel, tin-plated steel, copper, brass, bronze, or any other suitable type of metal) composite material, wax, glass, ceramic, or foam. Rigid Layer 002 may operate as a handle in some methods of use. (Embodiments exist where) rigid layer 002 may perform other functions in addition to serving as a handle. A container, enclosure, box, case, tin 003 may be present. Rigid layer 002 may operate as a lid to container 003. Rigid Layer 002 may be made of multiple parts. Embodiments exist in which one of the parts of Rigid Layer 002 may be an outer lid 004 and another part may be an inner lid 005. Outer lid 004 and, or inner lid 005 may be made of aluminum and may be of a shape that may be suitable for interacting with container 003 in such a way that container may sufficiently close. Outer lid 004 and, or inner lid 005 may be made of a material which may promote an attachment 006 to at least one of any of the other layers present as part of layers 001 which may be present in the embodiment. The attachment 006 may be sufficient on its own or in combination with other forms of attachment to cause all layers present to move in concert. Outer lid 004 and, or inner lid 005 may have a series of contours 007 present. The series of contours 007 may serve as a mechanical method of attachment between outer lid 004 and inner lid 005 or outer lid 004 and any other layers present as part of layers 001 or both. The series of contours 007 may be of a shape so as to facilitate ease of manipulation of hair, or facilitate ease of application of material to skin and, or hair, or increase structural integrity, or increase surface area which may in turn facilitate attachment to one or more layers, or facilitate ease of interacting with container 003 or any portion of container 003 or any combination of the described benefits. A hole, holes, vent, vents, opening, openings 008 may be present. The hole 008 may facilitate airflows relevant to outer lid 004 during 1 or more stages of production.

Inner lid 005 may be of a shape so as to interact with outer lid 004. Inner lid 005 may be positioned so as to allow at least one of any of the other layers present as part of layers 001 to pass between portions and, or all of inner layer 005 and outer layer 004. Such positioning may facilitate an attachment or increased attachment between rigid layer 002 and, or any of it components and at least one of any layers present as part of layers 001.

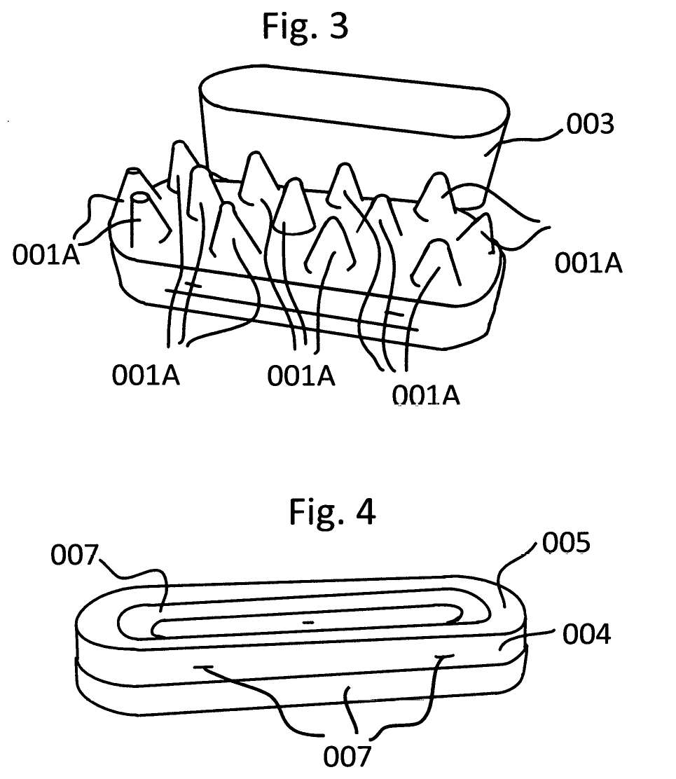

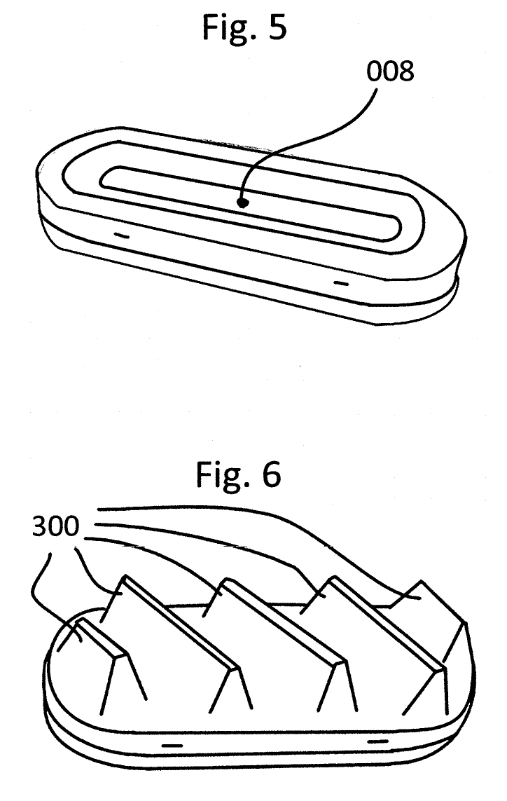

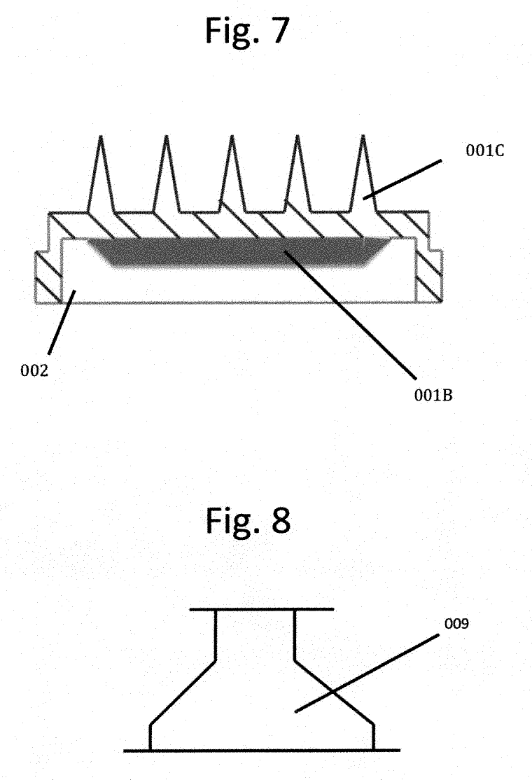

An attaching layer 001B may be present and may be of any suitable substance that may possess physical characteristics which may facilitate attachment. Such a layer may be present in the embodiment displayed in FIG. 3. For ease of understanding, the attaching layer is displayed in FIG. 7 as an orange section. It may be a layer that may be present between a top layer 001C and the rigid layer 002. Attaching layer 001B may facilitate the attachment of one or more layers.

### Operation of the 2nd Embodiment

A user may carry the embodiment with them. While carrying the embodiment, the embodiment may be in a closed position. This may be a position where any rigid layers 002 present may be interacting with a container 003. This closed position may make it easier for user to carry the embodiment in a pocket or with minimal risk of damage or contamination to embodiment or portions thereof. When user desires, the user may grasp the rigid layer 002 in one hand and the container 003 in another to open container. User may then move a portion of the embodiment in contact wither user's skin and, or hair. When satisfied, user may then place rigid layer back in contact with container. Other methods of use may exist. One or more of the methods of use may make it quick, easy, and convenient for user to enjoy the benefits of one or more of the layers present in the embodiment.

### Alternate Embodiments

A plug, anchor, attachment device, cover 009 and an accompanying hole may be present. Plug 009 may have two terminal ends. At least a portion of the plug 009 may enter into the accompanying hole. The shape may prohibit at least one portion of the plug 009 from passing through the hole when in at least one of its possible orientations. For example, a portion, the end with the smaller diameter, of the plug 009 present in FIG. 8 may be able to pass through the accompanying hole but the other end, with a larger diameter may not be able to pass through the accompanying hole. When used the plug 009 may pass through hole while one or more layers 001 is in a liquid state so as to serve as a mechanical lock when said one or more layers 001 solidify plug 009 may also serve to cover the accompanying hole so as to deter any unwanted substances from contacting other portions of any of the embodiments where the plug 009 is present. The shape and, or elements of plug 009 may further bolster its attaching characteristics by acting as an anchor of sorts.

Embodiments exist where layers may be organized in different arrangements. Some layers may be structures so that they are stacked one on top of the other. Layers may also be arranged so as to be side by side.

Layers 1000 may be of any suitable shape. For example, bottom layer 1000B may have an elongated portion to facilitate operation. Shape may be ergonomic in nature. Shape may be amusing.

Embodiments may exist where rigid layer 002 may not have an inner lid present.

Embodiments exist where a holder, rest, holster, perch 200 is present. Holder 200 may be of a shape that is a translation of or congruent to the shape of embodiment and may serve to give shape to one or more layers in the event that a layer or layers melt. Holder 200 may be a shape that is entertaining. For example, holder may resemble a character from a video game, or show, or any other person or thing real or imagined.

Embodiments exist where one more ridges 300 and, or slits 310 may be present. Ridges 300 or slits 310 may provide edges that are areas of contact with reduced surface area that may promote dispensing of hair product on the hair or skin or creating a desired sensation on the skin. Ridges 300 or slits 310 may also act as channels or tines facilitating the styling of hair.

Embodiments exist where elements are of a different size, shape and, or color. One or more embodiments exist where embodiment may appear like a spiked shell and a holder may be present and may look like a turtle. Spiked shell may fit in and, or on turtle shaped holder in a manner where it looks like the spike shell is on the turtle.

### Melting Point

Embodiments may exist which have different melting points for one or more of any layers that may be present. Embodiments exist with relatively low melting points. Lower melting points may provide for ease of application. Embodiments exist with relatively high melting points. High melting points may provide for ease in shipping or storage. Embodiments may exist wherein one or more of the layers that may be present have a melting point higher than the temperature of the human body. Such melting points may provide a variety of benefits.

### Packaging

Some embodiments may minimize or eliminate the need for packaging. For, example an outside layer may be present as part of an embodiment. Said layer may have a relatively high melting point. Outside layer may additionally be soluble in a solvent to which user has access. Solvent may be water. Some embodiments may have a packaging present. Packaging may be of a geometry that closely mimics the geometry of one or more of the layers that may be present. Packaging may be able to seal shut around one or more (up to and including all layers) that may be present. Packaging may seal by any suitable means including but not limited to screwing, closed, use of gaskets, use of seals such as those present in some forms of clamshell-style or blister-style packaging, magnetism, mechanical means, etc. Having packaging present as part of embodiment and of a specific geometry may allow for one or more layers of embodiment to fully or partially melt and harden while maintaining a desirable shape. Packaging may promote or retard adherence of one or more layers to packaging.

### Layers

Embodiments exist with a different number of layers. The number of layers may vary.

### Additional Implements may be Present

Additional implements may be present as part of embodiments. Implements may be partially embedded into embodiment. For example, an embodiment exists where a comb-type implement is embedded into the bottom layer of the embodiment in such a way that the tines of the comb-type implement extend out past a side wall of the bottom layer in an orientation that is generally perpendicular to said side wall. Thus, user may use comb-type implement as an additional form of grooming and thus an embodiment of this type may provide one type of grooming effect with any tines that may be present on the face of embodiment and provide another type of grooming effect with the tines present as part of the comb-type implement, and yet another type of grooming effect with the bare sidewall of the bottom layer or other layers present. Other implements may be present such as a bottle opener, bristles, and, or adornments as some examples. Implements may also be present as part of the container portion of the embodiment.

### Combination of Layers

The method of combining layers may vary. Embodiments exist where a first layer may be formed (method of forming may be by pouring first layer into a mold while in a liquid or semi-liquid state) and then a second layer may be formed or poured while portions of first layer are still molten. Such embodiments may tend to behave as one single body. Embodiments exist where a first layer is poured and allowed to cool substantially before a second or subsequent layers are poured. Embodiments of this type may tend to act as two connected but separate bodies. Embodiments of this type may allow for layers to be separated more easily and may even allow for layers to be interchanged.

### User Applied Layers

An embodiment exists where a base layer is present. Base layer may be made of any suitable material including plastic, wood, metal, glass, tempered glass, wax, and composite materials, amongst others. Additional layers may be added to base layer. Additional layers may be added by manufacturer and, or by users. Base layer may have a geometry that lends itself to being efficient at grooming hair. Users may add layers to base layer by any suitable means. One or more embodiments make use of a device known to some as a candle warmer. Manufacturer and, or users may warm a composition such as a balm similar to balm 100 with candle warmer. Then when the desired temperature and or physical state is reached, user and, or manufacturer may apply additional layer to base layer. Any suitable method may be used. One method of applying additional layer to base layer is by dipping base layer into warmed additional layer. Candle warmer may be a standard candle warmer or may be a candle warmer of specific design (such as warmer 400). Warmer may have a geometry that provides ease in applying additional layers and, or safety in doing so. For example, it may be of a size and depth to receive base layer and may only reach a maximum temperature. Warmer may have contours that generally match and, or mimic the contours of base layer and, or may have grooves present that align with notches on base layer and, or may have stops in place. Such a geometry may allow users who may not be skilled in appropriate techniques to apply second layers effectively and, or safely. Base layer may be of a design that encourages proper concert of additional layers with base layer. For example, if good connection is desired, base layer may have ridges, grooves, bulges, or barbs which encourage secure connection between base layer and additional layers when additional layers are put into place.

I claim:

1. An article comprising a plurality of layers said layers having at least a top layer and a bottom layer wherein at least one layer of said layers is made of a composition suitable for application to hair and, or skin and a means for attaching said layers sufficiently so that they move in tandem whereby the user may easily apply beneficial product to their hair or skin.

2. The article of claim 1 wherein said top layer has at least one portion of it formed into the shape of at least one tine, ridge, and or slit.

3. The article of claim 1 wherein at least one additional layer of said layers is made of a substance suitable for application to the hair and, or skin.

4. The article of claim 2 wherein at least one additional layer of said layers is made of a substance suitable for application to the hair, and or skin.

5. The article of claim 2 wherein at least one of the said layers is a rigid layer.

6. The article of claim 5 further comprising a container with a series of contours wherein said rigid layer has a series of contours sufficiently complementary to said container so as to allow said rigid layer to serve as a lid to said container.

7. The article of claim 5 wherein said rigid layer comprises an outer lid and an inner lid and a means for attaching the outer lid to the inner lid.

8. The article of claim 6 wherein said rigid layer comprises an outer lid and an inner lid and a means for attaching the outer lid to the inner lid.

9. The article of claim 8 further comprising at least one hole on at least one surface of said rigid layer.

10. The article of claim 9 further comprising a plug said plug having at least 2 terminal ends and being positionable in a variety of orientations and having a diameter sufficiently small enough to allow at least a portion of one of at least one of the said terminal ends to pass through at least one of said holes, and having a means to prevent at least a portion of at least one of said terminal ends of passing through said hole.

11. A plurality of layers said layers having at least a top layer and a bottom layer wherein at least one layer of said layers is made of a composition suitable for application to hair and, or skin and an attachment between said layers so that they move in tandem whereby the user may easily apply beneficial product to their hair or skin.
A method, comprising

12. Providing a plurality of layers said layers having at least a top layer and a bottom layer wherein at least one layer of said layers is made of a composition suitable for application to hair and, or skin and a means for attaching said layers sufficiently so that they move in tandem whereby the user may easily apply beneficial product to their hair or ski
